(19) United States
(12) Patent Application Publication
(10) Pub. No.: US 2012/0247277 A1
(43) Pub. Date: Oct. 4, 2012

(54) Extractor apparatus for a bottle stopper

(76) Inventor: Matthew Moore, Madisonville, LA (US)

(21) Appl. No.: 13/065,795

(22) Filed: Mar. 30, 2011

(51) Int. Cl. B67B 7/02

(52) U.S. Cl. 81/3.44

(57) ABSTRACT

An extractor for removal of plastic stopper from liquid-containing bottles is formed as pliers with inwardly facing wedge-shaped jaw portions. Cutouts formed in the jaw portions allow them to encircle the stopper under the flange. Squeezing force applied to the jaw portions gradually wedges the jaw portions between the flange of the stopper and the neck of the bottle, thereby unseating the stopper and allowing its extraction from the bottle without spilling contents of the bottle.

### BACKGROUND OF THE INVENTION

This invention relates to stopper removal apparatus for removing a plastic stopper of the type used as a closure for glass bottles containing liquids, such as ink, medications and the like.

Conventionally, liquid ink and medications are packaged in bottles having a narrow neck. A plastic stopper with a peripheral circular upper flange is inserted in the opening of the bottle neck such that the flange seats on the bottle neck edge, while the stopper body is inserted into the bottle. The sealing force of the flange prevents the contents of the bottle from spilling even if the bottle is shaken or turned upside down.

While the packaging works satisfactory in transit removal of the bottle stopper presents a problem. Some of the contents of a bottle can get in between the stopper and the inside of the bottle neck. The liquid ink or medication may dry causing the stopper to stick to the bottle. Or, the stopper can get stuck because the flange was forced against the bottle neck edge too tightly. Whatever the case, the stopper needs to be removed before the bottle contents can be used.

As is often the case, the ink and medicament bottles are made of flexible plastic. Therefore any squeezing force applied to the bottle while removing the stopper may cause the contents of the bottle to spill on the clothes, thereby ruining the clothes.

One of the suggested methods of removing a stuck stopper is to heat the neck of the bottle so as to cause its thermal expansion, which will loosen the stopper. However, such method may not be appropriate for a medication bottle, where the medicament must be kept cool. Other methods suggest placing the bottle neck under a stream of running water to gradually dissolve the dried out particles and also loosen the stopper. While this method may work satisfactory where the running water is readily available the same method may not work when the contents of the bottle may change the physical or chemical properties or when the medication is needed immediately.

The present invention contemplates elimination of drawbacks associated with conventional methods of extracting a bottle stopper and provision of an apparatus that can be easily applied for removal of a stopper from a neck of a bottle.

### SUMMARY OF THE INVENTION

It is, therefore, an object of the present invention to provide an apparatus for extracting a bottle stopper.

It is another object of the invention to provide an apparatus for removing plastic bottle stoppers.

It is a further object of the invention to provide a pliers-type apparatus for removing bottle stoppers.

These and other objects of the invention are achieved through a provision of an extractor for removal of plastic stopper from liquid-containing bottles is formed as pliers with inwardly facing wedge-shaped jaw portions. Cutouts formed in the jaw portions allow them to encircle the stopper under the flange. Squeezing force applied to the jaw portions gradually wedges the jaw portions between the flange of the stopper and the neck of the bottle, thereby unseating the stopper and allowing its extraction from the bottle without spilling contents of the bottle.

The handles of the extractor can form a modified X-configuration or can be generally J-shaped with curved handles and lower portions. The semi-circular cutouts formed in the jaw portions can be sized to almost completely encircle the stopper when the jaws are closed.

### BRIEF DESCRIPTION OF THE DRAWINGS

Reference will now be made to the drawings, wherein like parts are designated by like numerals, and wherein

FIG. 1 is a front view of the apparatus for extracting bottle stoppers according to the first embodiment of this invention, with the jaw portions in an open position.

FIG. 2 is an end view of the jaw portions of the stopper extractor apparatus according to the first embodiment of the invention.

FIG. 3 is a perspective view illustrating the jaw portions engaging the bottle stopper under the flange.

FIG. 4 is a perspective view illustrating extraction of the bottle stopper using the extractor apparatus of the first embodiment.

FIG. 5 is a perspective view of the extractor apparatus according to the second embodiment of this invention.

FIG. 6 is a perspective view of a first handle member of the extractor apparatus according to the second embodiment.

FIG. 7 is a perspective view of a second handle member of the extractor apparatus according to the second embodiment.

FIG. 8 illustrates engagement of the bottle stopper by the jaw portions of the extractor apparatus according to the second embodiment.

FIG. 9 is an end view of the closed jaw portions of the extractor apparatus according to the second embodiment.

FIG. 10 illustrates the jaw portions of the extractor apparatus of the present invention being wedged between the peripheral lip and a top edge of a liquid-containing bottle.

### DETAIL DESCRIPTION OF THE INVENTION

Turning now to the drawings in more detail, numeral 10 designates the extractor apparatus according to the first embodiment. The extractor apparatus 10 comprises two handle members 12 and 14, each handle member being formed as a unitary body. The handle members 12 and 14 are pivotally connected by a pivot pin 16 at a fulcrum point. The extractor apparatus has a generally X-shaped configuration, where the handle portions intersect at the fulcrum point. An imaginary vertical plane extends through the fulcrum point. The coupling together of the two handle members 12, 14 enables the extractor apparatus 10 to be opened and closed by pulling apart or squeezing together the handle members 12, 14, in a scissor-like manner, about the fulcrum point defined by the pivot pin 16.

The first handle member 12 comprises an upper part 20, a middle part 22, a lower part 24 and a jaw portion 26. Similarly, the second handle member 14 comprises an upper part 30, a middle part 32, a lower part 34 and a jaw portion 36. The upper part 20, the middle part 22 of the first handle member 12 are oriented on one side of the imaginary vertical plane along with the lower part 34 and the jaw portion 36 of the second handle member. The upper part 30, the middle part 32 of the second handle member 14 are oriented on the other side of the imaginary vertical plane along with the lower part 24 and the jaw portion 26 of the first handle member.

In one aspect of the invention, the upper parts 20 and 30 of the handle members 12 and 14 are mirror images of each other. The upper parts 20 and 30 extend away from each other, forming a Y-shaped connection at the fulcrum point. The middle parts 22 and 32 have aligned openings, through which the pivot pin 16 extends. The lower parts 24 and 34 also extend away from each while forming a Y-shaped connection at the fulcrum point.

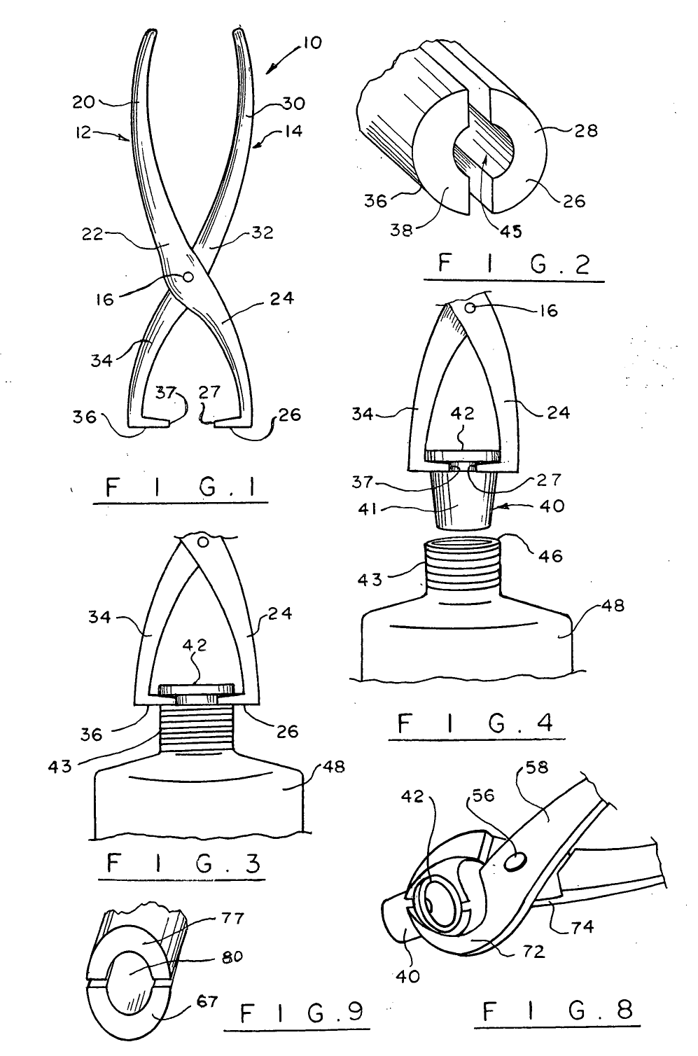

The jaw portions 26 and 36 extend substantially transversely to the imaginary vertical plane and to the lower parts 24, 34, respectively. As can be seen in FIG. 1, the jaw portions 24, 34 extend transversely to a longitudinal axis of the handle member 12 and 14. Each jaw portion 26 and 36 is wedge-shaped, with narrow edges 27, 37 facing each other and extending inwardly in relation to the lower parts 24, 34. The wider parts of the jaw portions 26, 36 are secured to the lower parts 24, 34 of the handle member 12 and 14. The jaw portions have a generally semi-circular cross-section and curved bottom lips 28, 38, respectively.

FIG. 2 illustrates the opening formed by the jaw portions when the handle members 12 and 14 are moved into a closed position around a bottle stopper 40. When in a closed position, the jaw portions 26, 36 form a generally circular opening 45 by their inwardly facing surfaces. The opening 45 can differ in diameter depending on the size of the pliers 10 and the size of the stopper 40 being extracted. In one of the preferred embodiments, the opening 45 is 9/16″ in diameter when the jaws are closed.

In operation, the user positions the extractor apparatus 10 such that the narrow curved edges 27, 37 of the jaw portions 24, 34 are squeezed between a peripheral flange 42 and a top edge 46 of a closed bottle 48. See FIG. 10. Normally, the peripheral flange 42 rests on top of the edge 46 and a conical body 41 of the stopper 40 extends into the neck 43 of the bottle 48. The user applies a squeezing force to the upper parts 20, 30 of the handle members 12 and 14, which causes the jaw portions 26, 36 to close around the stopper 40. The jaw portions in a closed position are configured to form an opening sized to be at least slightly greater than the stopper and at least slightly smaller than a flange of the stopper such that the pulling force is applied to the stopper while the jaws urge against underside of the flange.

The wedge-shaped jaws gradually increase the space between the peripheral flange 42 and the top edge 46 of the bottle 48 until the jaws almost completely encircle the body 41 of the stopper 40 under the peripheral flange 42. The user can they apply an upward pulling force to the stopper 40 and extract the stopper 40 from the bottle 48 without spilling the contents of the bottle 48. As the outward force is applied to the stopper 40 the flange 42 prevents the jaw portions from slipping and disengaging from the stopper 40. The pulling force can be applied until the stopper is completely or at least partially extracted from the bottle. The user can manually twist and pull the partially extracted stopper 40 to remove it completely.

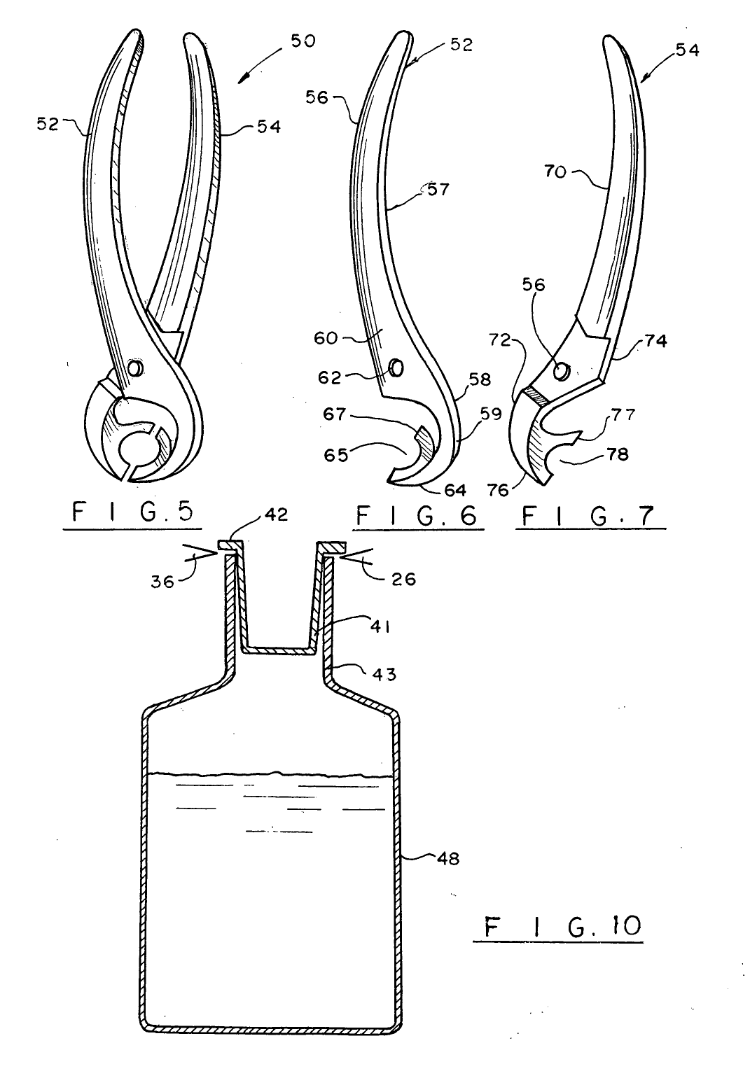

Turning now to the second embodiment of the present invention shown in FIGS. 6-9, the extractor apparatus is generally designated by numeral 50. The apparatus 50 comprises a pair of elongated J-shaped handle members 52 and 54 connected together by a pivot pin 56. The first handle member 52 has an upper part 56, a lower part 58, and a connecting part 60 unitary connected between the upper part 56 and the lower part 58. An opening 62 is formed in the connecting part 60. The upper part 56 and the connecting part 60 have a concave inner surface 57, and the lower part 58 has an outwardly convex outer surface 59 curving in a direction opposite to the concave inner surface 57.

The lower part 58 has a curved configuration and terminates with a jaw portion 64. Similarly to the jaw portion 26, the jaw portion 64 has a semi-circular cutout 65 and a wedge-shaped configuration. The innermost edge 67 of the jaw portion 64 is narrow, while the thickness of the jaw portion increases away from the edge 67.

An imaginary vertical plane intersects the first handle member 52 along the center of the opening 62. The upper part 56 of the first handle member 52 extends on one side of the imaginary vertical plane while the lower part 58 curves away from upper part 56 and then curves inwardly toward the imaginary vertical plane.

The second handle member 54 has an elongated body with an upper part 70, a lower part 72, and a connecting part 74 unitary connected between the upper part 70 and the lower part 72. The connecting part 74, similarly to the connecting part 60 has a reduced thickness to allow the handle members to be joined together in the form of pliers. The pivot pin 56 is secured to the connecting part 74 and extends outwardly therefrom. The connecting pin is configured to extend through the opening 62 when the handle members 52 and 54 are joined together.

A jaw portion 76 extends from the lower part 72; the jaw portion curves inwardly, away from the lower part 72, as shown in FIG. 7. An imaginary vertical plane intersects the second handle member 54 along the fulcrum point defined by the pivot pin 56. The upper part 70 extends on one side of the imaginary vertical plane, while the lower part 72 and the jaw portion 76 extend on the opposite side of the imaginary vertical plane.

Similarly to the jaw portion 64, the jaw portion 76 has a wedge-shaped configuration, with the narrow edge 77 facing inwardly and a thicker part connecting to the lower part 72. The jaw portion 76 is provided with a semi-circular cutout 78, which is a mirror image of the cutout 65. When the handle members 52 and 54 are joined together as shown in FIG. 5, a generally round opening 80 is formed between the jaw portions 64 and 76. In one of the preferred embodiments, the opening 80 is about 9/16″ in diameter when the jaws are closed.

In operation, the user grasps the bottle with one hand and the extractor apparatus with the other. The user positions the jaw portions 64, 76 around the stopper 40 guiding the edges 67 and 77 of the jaw portions 64, 76 under the peripheral flange 42. The user squeezes the handle members 54, 56 forcing them together and forcing the jaw portion to enter into a space between the edge of the bottle neck and the peripheral flange. As the jaw portions wedge into the created space the stopper 40 is gradually lifted from the bottle. Once the jaws encircle the stopper 40 the user can apply a pulling force and extract the stopper 40 from the bottle neck 43. The flange 42 of the stopper 40 prevents the jaw portions from slipping along the outer surface of the stopper.

In one of the preferred embodiments the handle members 12, 14, 52 and 54 were about 5″ long and made of sturdy plastic. Of course, other sizes and materials can be used in the manufacture of the extractor apparatus of the present invention. If desired, the jaw portions can be provided with a square cutout to accommodate square stopper. The jaws can be designed to accommodate stoppers of 2-, 4-, or 8-oz bottles. Many other changes and modifications can be made in the design of the present invention without departing from the spirit thereof. I, therefore, pray that my rights to the present invention be limited only by the scope of the appended claims.

I claim:

1. An apparatus for extraction of a flanged stopper positioned in a neck of a bottle, the apparatus comprising:
a pair of elongated handle members connected by a pivot, each handle member provided with a jaw portion on a lower part thereof, each jaw portion being generally wedge-shaped and provided with a cutout configured to encircle at least a part of the stopper under a flange of the stopper and to be wedged between the flange of the stopper and the neck of the bottle.

2. The apparatus of claim 1, wherein the jaw portions extend transversely to longitudinal axes of the handle members.

3. The apparatus of claim 1, wherein each of the handle members has a generally J-shaped configuration.

4. The apparatus of claim 1, wherein the handle members are configured to form X-shaped pliers.

5. The apparatus of claim 1, wherein each jaw portion is provided with a semi-circular cutout.

6. The apparatus of claim 1, wherein each handle member comprises an upper part, a middle part and a lower part, and wherein a fulcrum point is formed in the middle part, said fulcrum point being defined by a pivot pin connecting the handle members.

7. The apparatus of claim 1, wherein each of the handle members comprises an upper part, a lower part, and a connecting part, and wherein a fulcrum point is formed in the connecting part, said fulcrum point being defined by a pivot pin connecting the handle members.

8. The apparatus of claim 7, wherein the upper part and the connecting part have a concave inner surface, and the lower part has an outwardly convex outer surface curving in a direction opposite to the concave inner surface.

9. The apparatus of claim 1, wherein the jaw portions in a closed position are configured to form an opening sized to be at least slightly greater than the stopper and at least slightly smaller than a flange of the stopper.

10. A method of extracting a flanged stopper positioned in a neck of a bottle, the method comprising the steps:
providing a pair of pivotally connected elongated handle members, each handle member having a jaw portion on a lower part thereof, each jaw portion being generally wedge-shaped and provided with a generally semi-circular cutout in inwardly facing surface;
positioning the jaw portions between a flange of the stopper and the neck of the bottle;
applying a squeezing force to the jaw portions thereby wedging the jaw portions between the flange of the stopper and the neck of the bottle until the jaw portions substantially encircle the stopper;
applying a pulling force to the stopper thereby extracting the stopper from the neck of the bottle.

11. The method of claim 10, further comprising a step of gradually wedging the jaw portions between the flange of the stopper and the neck of the bottle thereby partially removing the stopper from the neck of the bottle.

12. The method of claim 10, wherein the jaw portions extend transversely to longitudinal axes of the handle members.

13. The method of claim 10, wherein each of the handle members has a generally J-shaped configuration.

14. The method of claim 10, wherein the handle members are configured to form X-shaped pliers.

15. The method of claim 10, wherein each of the handle members comprises an upper part, a lower part, and a connecting part, and wherein a fulcrum point is formed in the connecting part, said fulcrum point being defined by a pivot pin connecting the handle members.

16. The method of claim 15, wherein the upper part and the connecting part have a concave inner surface, and the lower part has an outwardly convex outer surface curving in a direction opposite to the concave inner surface.

17. The method of claim 10, wherein the jaw portions in a closed position are configured to form an opening sized to be at least slightly greater than the stopper and at least slightly smaller than a flange of the stopper such that the pulling force is applied to the stopper while the jaws urge against underside of the flange.
